(19) United States
(12) Patent Application Publication
(10) Pub. No.: US 2024/0338553 A1
(43) Pub. Date: Oct. 10, 2024

(54) RECOMMENDING BACKGROUNDS BASED ON USER INTENT

(71) Applicant: Adobe Inc., San Jose, CA (US)

(72) Inventors: Sanat SHARMA, Austin, TX (US); Kerem TURGUTLU, Mountain View, CA (US); Jayant KUMAR, San Jose, CA (US); Jay JAGANAATH, Atlanta, GA (US); Fengbin CHEN, Los Gatos, CA (US)

(73) Assignee: Adobe Inc., San Jose, CA (US)

(21) Appl. No.: 18/295,665

(22) Filed: Apr. 4, 2023

(51) Int. Cl. G06N 3/0455; G06N 3/08

(52) U.S. Cl. CPC G06N 3/0455; G06N 3/08

(57) ABSTRACT

Embodiments are disclosed for recommending backgrounds based on user intent. A method of recommending backgrounds based on user intent may include obtaining a design context and generating, by an embedding generator, an intent embedding based on the design context. One or more candidate background embeddings may be determined based on a similarity between the intent embedding and a plurality of candidate background embeddings in embedding space. One or more recommended background images may be identified based on one or more background classes corresponding to the one or more candidate background embeddings.

### BACKGROUND

Advances in computer processing and machine learning have led to significant advancements in the field of digital content generation and editing. Specifically, many systems provide digital content editing applications with a large number of different tools to perform a variety of operations. For instance, many systems provide tools, panels, and settings to generate and modify digital images, digital video, and digital text for creating different types of digital resource items (e.g., content). Visual designers often make use of readymade content, such as templates, images, etc. to incorporate into their designs. Such content is typically searchable by the designer and may be made available through a design application or accessed externally, such as from a web site or other content repository.

### SUMMARY

Introduced here are techniques/technologies that provide background image recommendations based on user intent. Embodiments determine what a user's intent is from a design context and then match this intent to candidate background images. For example, the user intent can be determined from broader design context (e.g., what has the user added to the digital canvas), an explicit query, etc. At inference time, an embedding is generated for the intent and matched to the nearest background embeddings in the embedding space. The background embeddings correspond to background classes or categories. The matching background embeddings are mapped back to their corresponding background classes are then used to retrieve suggested backgrounds from the image library.

More specifically, in one or more embodiments, the embedding generator is trained to generate embeddings for intent and background classes in the same embedding space. In particular, a triplet loss is used such that embeddings of intents and matching backgrounds are generated to be close to one another in the embedding space and distant from non-matching backgrounds.

Additional features and advantages of exemplary embodiments of the present disclosure will be set forth in the description which follows, and in part will be obvious from the description, or may be learned by the practice of such exemplary embodiments.

### BRIEF DESCRIPTION OF THE DRAWINGS

The detailed description is described with reference to the accompanying drawings in which:

FIG. 1 illustrates a diagram of a process of recommending background images based on user intent, in accordance with one or more embodiments;

FIG. 2 illustrates an example of background images recommended based on user intent, in accordance with one or more embodiments;

FIG. 3 illustrates a diagram of a user interface for recommending background images based on user intent, in accordance with one or more embodiments;

FIG. 4 illustrates a diagram of a process of generating a training dataset, in accordance with one or more embodiments;

FIG. 5 illustrates an example of a portion of the training dataset, in accordance with one or more embodiments;

FIG. 6 illustrates a diagram of a process of training an intent encoder, in accordance with one or more embodiments;

FIG. 7 illustrates a schematic diagram of a background recommendation system in accordance with one or more embodiments;

FIG. 8 illustrates a flowchart of a series of acts in a method of recommending background images based on user intent, in accordance with one or more embodiments; and

FIG. 9 illustrates a block diagram of an exemplary computing device in accordance with one or more embodiments.

### DETAILED DESCRIPTION

One or more embodiments of the present disclosure include a background recommendation system which recommends one or more background images based on a user's design context. Increasingly, design systems have become more accessible to average users. This enables communicators and light-weight creative users to create composites such as cards, flyers, social media posts, covers, etc. One of the first steps in the creative journey of these users is to search for the right backgrounds which could act as a good starting point.

Conventional systems provide a user interface front end for searching an image catalog. The image catalog may be organized by categories (which may or may not be known to an average user), the images may be tagged with keywords or other metadata, or some other indexing scheme may be in place that a curator believes will assist users in finding appropriate images. However, searching a large image catalog to find relevant images can be difficult for casual or inexperienced users. Additionally, average users may use different search terms than a curator expects. This makes searching for relevant images frustrating, which may discourage the user from continuing work on their project.

Additionally, machine learning has led to a number of recommendation systems. For example, with the growth of deep learning, embedding-based ranking techniques have also been used as zero-shot recommender systems. Similarly, knowledge graphs and graph neural networks have also emerged as good candidates at understanding context and providing zero-shot recommendations. However, such systems have proved challenging to implement for searching background images specifically. For example, in one prior approach, a parser was used on stock image titles to extract ‘foreground’ and ‘background’ objects from the titles and these foreground-background pairs were used for learning.

Using these foreground-background pairs, term frequency-inverse document frequency (TF-IDF) scores were calculated and the scores were used as weights for training purposes, to learn the ‘most interesting’ backgrounds for every foreground of an image. However, this parsing-based association is error prone and often did not accurately capture user intent, resulting in a noisy training dataset and a poorly performing model.

To address these and other deficiencies in conventional systems, the background recommendation system of the present disclosure determines a user's intent based on a design context. This design context may include a specific query received from the user and/or may be based on what the user has so far created within a design application. For example, when the user opens a design application, they may be presented with a digital canvas in which the user can draw and/or add text, backgrounds, borders, images, and other visual elements. The user's intent can be extracted from this context information and used to identify candidate matching background classes. Additionally, an improved, less noisy, dataset is constructed, allowing for more accurate modeling.

In some embodiments, an intent encoder generates an embedding based on the intent. The embedding is a vector representation of the intent within a high dimensional embedding space. The intent encoder is trained to encode both intents and background classes within the same embedding space. Additionally, the training ensures that matching intents and background classes are encoded as embeddings that are close to one another within the embedding space while non-matching backgrounds are encoded as embeddings more distant from non-matching intents. This allows for matching backgrounds to be quickly retrieved when a new intent is received. The matching backgrounds can then be presented to the user to add to their design.

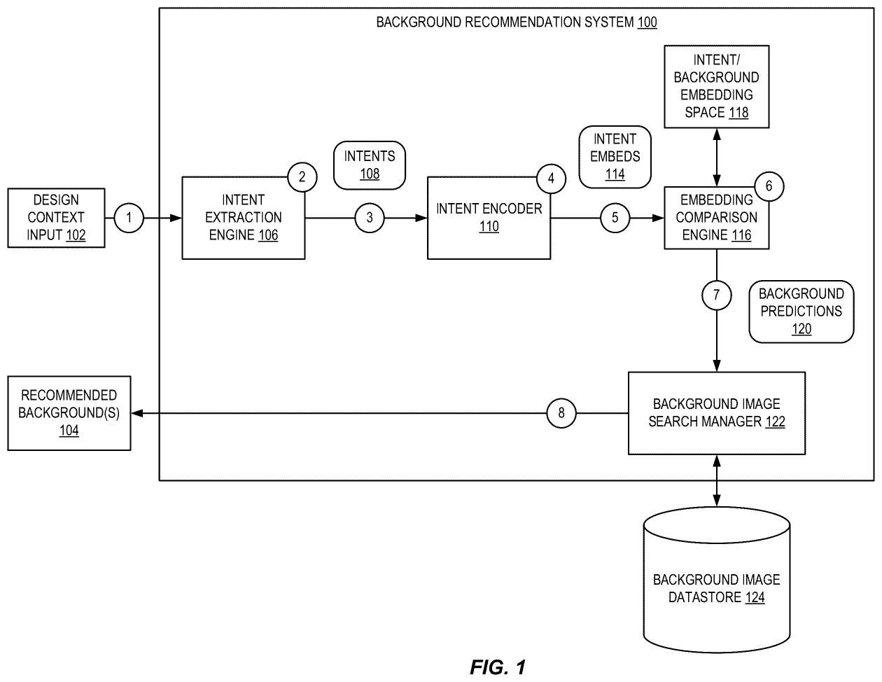

FIG. 1 illustrates a diagram of a process of recommending background images based on user intent, in accordance with one or more embodiments. As shown in FIG. 1, background recommendation system 100 can receive a design context input 102 and provide one or more recommended backgrounds 104. In some embodiments, background recommendation system 100 may be implemented as part of a digital design application, such as a graphics editor, photo editor, video editor, etc., or as part of a front-end interface for an image repository. Additionally, or alternatively, the background recommendation system 100 may be implemented as a standalone service that receives a design context 102 as a design document, query, etc. and returns one or more recommended background images 104.

At numeral 1, the background recommendation system 100 receives the design context input 102. In some embodiments, the design context is received continuously, as the user generates and/or edits content on a digital canvas of a digital design application. Additionally, or alternatively, the design context is received upon the user affirmatively interacting with a user interface associated with the background recommendation system (e.g., inputting a query, etc.). The design context 102 is received by intent extraction engine 106.

At numeral 2, the intent extraction engine 106 identifies a user intent, or set of intents, from the design context 102. In some embodiments, the intent extraction engine includes a digital knowledge graph which maps intent(s) to all or some of the design context. In such instances, the digital knowledge graph includes intents and background classes as nodes, with related intents and background classes forming clusters within the graph. In some embodiments, the knowledge graph may use a machine learning model which has been trained to predict an intent from the design context. In this way, the intent may summarize a mood, sentiment, object understanding, or other information from the design context analyzed by the intent extraction engine.

The resulting intent(s) 108 are provided to an intent encoder 110 at numeral 3. The intent encoder 110 may include a machine learning model, such as a neural network, which has been trained to generate a representation of an input intent in a high dimensional embedding space. A neural network may include a machine-learning model that can be tuned (e.g., trained) based on training input to approximate unknown functions. In particular, a neural network can include a model of interconnected digital neurons that communicate and learn to approximate complex functions and generate outputs based on a plurality of inputs provided to the model. For instance, the neural network includes one or more machine learning algorithms. In other words, a neural network is an algorithm that implements deep learning techniques, i.e., machine learning that utilizes a set of algorithms to attempt to model high-level abstractions in data. In particular, the intent encoder 110 may be trained to generate representations of both intents and background classes in the same embedding space, such that matching intents and background classes are located close to one another in the embedding space. At numeral 4, the intent encoder 110 generates intent embedding(s) 114 from the input intent(s) 108.

The intent embedding(s) 114 are provided to an embedding comparison engine 116, as shown at numeral 5. At numeral 6, the embedding comparison engine 116 can identify matching background(s) by identifying background classes that are close to the intent embedding(s) 114 in intent/background embedding space 118. As discussed, the embedding space may be a high dimensional vector space in which representations of both intents and background classes have been encoded by intent encoder 110. The matching background classes may be identified using a distance metric, such as L2 distance, or cosine similarity. For example, the top k closest background classes may be identified as matching backgrounds.

At numeral 7, the embedding comparison engine 116 can output these matching backgrounds as background predictions 120. In some embodiments, the embedding comparison engine 116 can map the close background embeddings to their corresponding background classes before passing along the background predictions 120. The background predictions 120 are received by background image search manager 122. Background image search manager 122 may comprise a front-end interface for an image datastore, such as background image datastore 124, which may be provided as part of background recommendation system 100, the digital design application, or as a standalone or third-party image repository. The background image search manager 122 can background images associated with the background class prediction(s) 120 from the background image datastore 124 and, at numeral 8, return them as recommended background(s) 104.

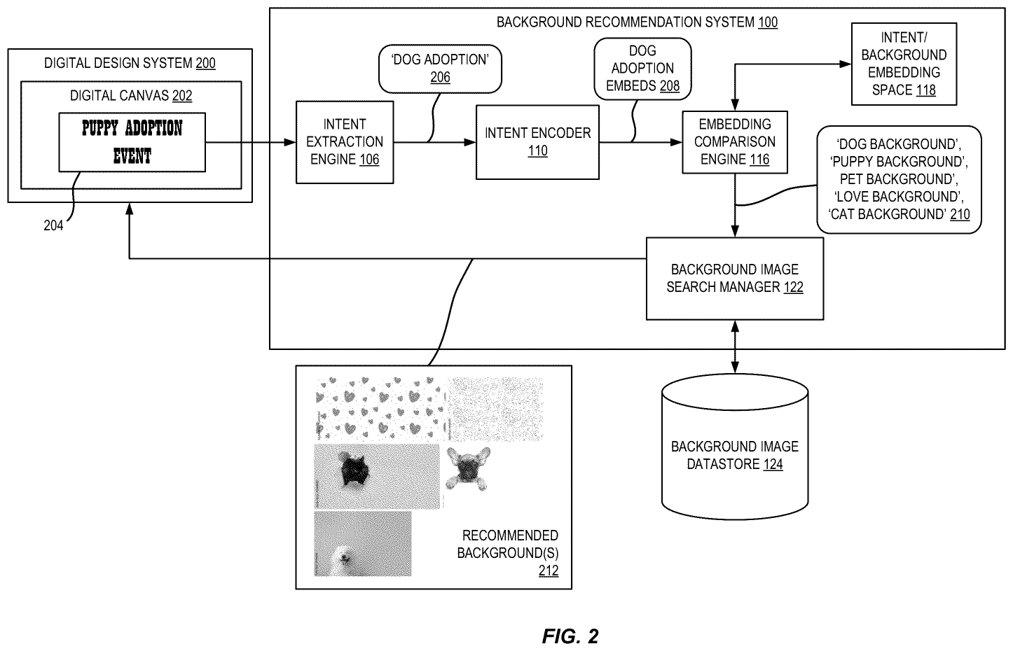

FIG. 2 illustrates an example of background images recommended based on user intent, in accordance with one or more embodiments. As shown in FIG. 2, a digital content system 200 can include a digital canvas 202. The digital content system can be implemented as a digital design application, such as a graphics editor, image editor, etc. The user can generate or edit on the digital canvas which results in a design context 204.

In the example of FIG. 2, the user has added text “Puppy Adoption Event” to the digital canvas. This text is then provided to intent extraction engine 106. As discussed, the intent extraction engine 106 maps the text context to a “dog adoption” intent 206. This is then provided to intent encoder 110. As discussed, intent encoder generates a representation of the “dog adoption” intent 206 to generate dog adoption embedding 208. The embedding comparison engine 116 can then identify matching background embeddings in intent/background embedding space.

For example, as discussed, the embedding comparison engine 116 may identify close embeddings in the embedding space to the dog adoption embedding using a distance metric, cosine similarity, or other metric. In the example of FIG. 2, the dog adoption embedding is matched to a plurality of background classes 210 including ‘dog background’, ‘puppy background’, pet background’, ‘love background’, and ‘cat background’. As discussed, the embedding comparison engine 116 may identify the background embeddings corresponding to these background classes 210 and then map the embeddings back to the background classes 210.

Background image search manager 122 can then use these background classes to identify matching background images in background image datastore 124. An example of some recommended background images 212 are shown. These may include an example image from each class, images that belong to multiple classes, or other search or ranking techniques as may be implemented by the background image datastore and/or background image search manager. These images are then made available to the user in digital design system 200.

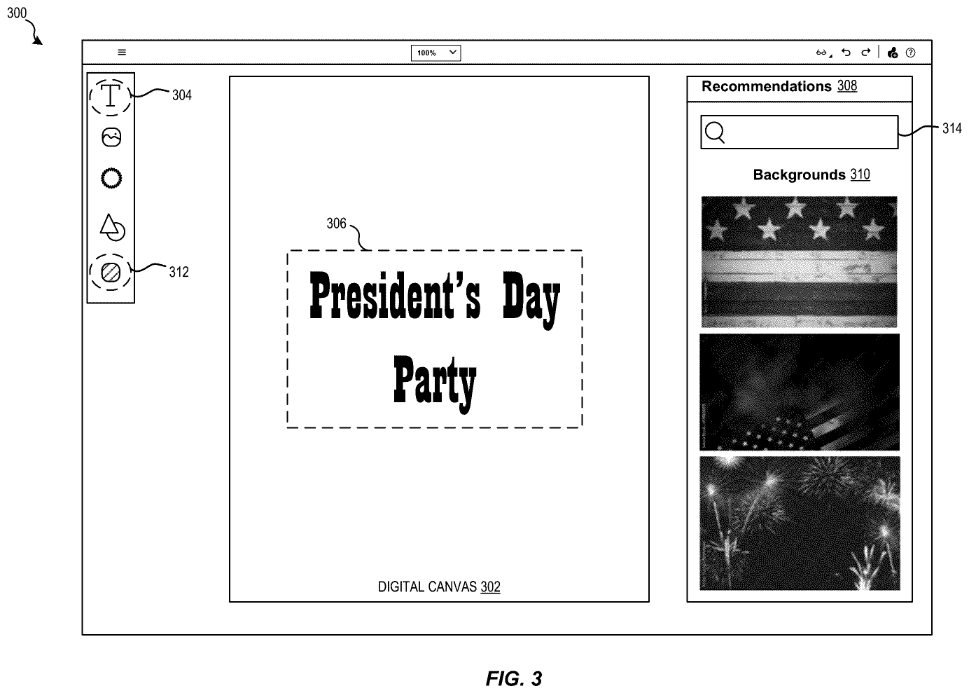

FIG. 3 illustrates a diagram of a user interface 300 for recommending background images based on user intent, in accordance with one or more embodiments. In the example of FIG. 3, user interface 300 is provided by a digital design application. The user interface 300 includes a digital canvas 302 on which the user can create their design. In this example, the user selects a text tool 304 and adds text 306 to the digital canvas. As shown, the text 306 is “President's Day Party.”

As discussed, the design context is created/updated as the user generates or edits content on the digital canvas. This context may be continuously, or periodically, provided to the background recommendation system, as described herein, to identify background images to recommend to the user. For example, the user interface 300 may include a recommendations panel 308. As the user begins creating content on the digital canvas, the resulting design context is passed to the background recommendation system automatically and recommended background images 310 are automatically populated in the recommendations panel 308. This provides an improved user experience, resulting in faster project creation time and increased engagement.

In some embodiments, the background recommendations may be provided on demand, rather than automatically. For example, the user may create their initial design on the digital canvas 302 and then select background tool 312. Upon selection, the current design context is sent to the background recommendation system and recommended backgrounds are presented in recommendations panel 308. In some embodiments, the design context may be augmented, or replaced, by query data. For example, recommendations panel 308 may include search box 314. The user may enter a text query into search box 314 which may be added to the design context or override the design context. For example, after receiving the initial background recommendations, the user may add an additional term to further refine their intent, such as by specifying a color, range of colors, objects or other content, etc. The user may select an image from background images 310 to have it added to the digital canvas 302.

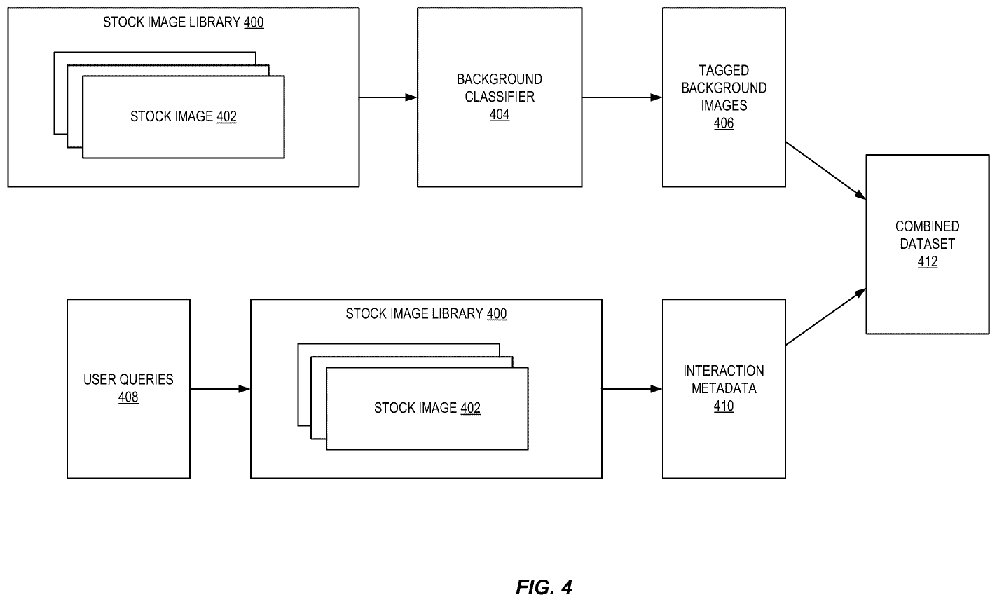

FIG. 4 illustrates a diagram of a process of generating a training dataset, in accordance with one or more embodiments. Ideally, a training dataset captures features that mimic user behavior and context, enabling the model to learn more accurate relationships between user intent and background images. To do so, embodiments combine two diverse datasets: background classifier dataset and a user click dataset.

As shown in FIG. 4, a first dataset is generated using a background classifier. The background classifier dataset is created by taking a plurality of stock images 402 from a stock image library 400 (or any images that feature background content from an image library) and passing them through a pretrained background classifier 404. The background classifier 404 classifies the background of stock image into one of a plurality of background classes which the background classifier 404 has been trained to recognize. The background classifier tags each stock image 402 with the identified background class.

In some embodiments, the background classifier 404 is trained using a pretrained EfficientNet B2 model and pre-trained on ImageNet dataset. For images with both foreground and background content, a box with random noise was added on the foreground during training to get background tags and embedding. This dataset on its own can have uneven label distribution and is limited by the classes known to the classifier. Additionally, if the image data used to pretrain the classifier does not resemble the image data used at inference, the results may be error prone. This dataset also does not model user preferences or interaction.

Accordingly, to obtain user preferences a user click dataset is also obtained for training. In some embodiments, a user click dataset can be built based on metadata associated with a stock image library. For example, as users query 408 the stock image library 400, query-document click metadata 410 is generated. This indicates the query entered by the user and which images (by content ID) the user ultimately selected to use (e.g., “clicked on”). This enables the click data corresponding to each image in the Background Classifier Dataset to be obtained. Accordingly, this indicates the query or queries that result in each tagged image being clients 406, based on real world user data along with a corresponding relevancy score (such as udtri, indicating unbiased impressions with forward actions).

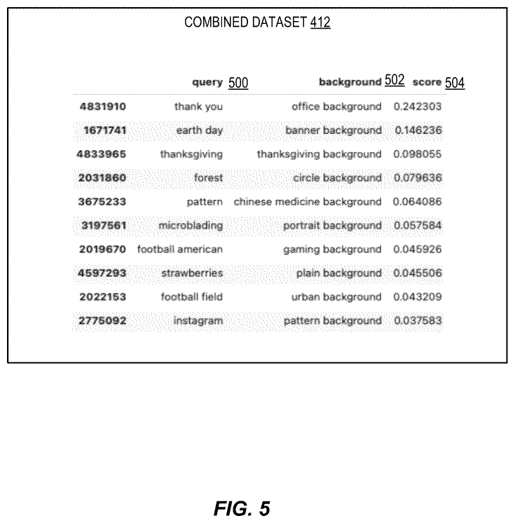

A combined dataset 412 is then created based on the two datasets. As multiple identical query-background pairs may have different relevancy scores, the relevancy scores are normalized. This allows for unique flattened (query, background, score) triplets for training purposes. For example, FIG. 5 illustrates an example of a portion of the combined training dataset 412, in accordance with one or more embodiments. As shown in FIG. 5, the combined dataset includes a plurality of query 500, background 502, score 504, triplets. In some embodiments, the query 500 represents the user intent associated with the background and score. In one example embodiment, the combined dataset includes 323 backgrounds and 26.4 million Query-Background-Score Triplets.

In some embodiments, data augmentations may also be applied to the combined dataset 412 to reduce noise and improve performance. For example, the queries may be sampled based on query frequency (e.g., sampling the top 100 k unique queries by query frequency). Additionally, solid color backgrounds may be removed. Also, the combined dataset may be filtered based on score thresholds, to remove low scoring triplets from the dataset.

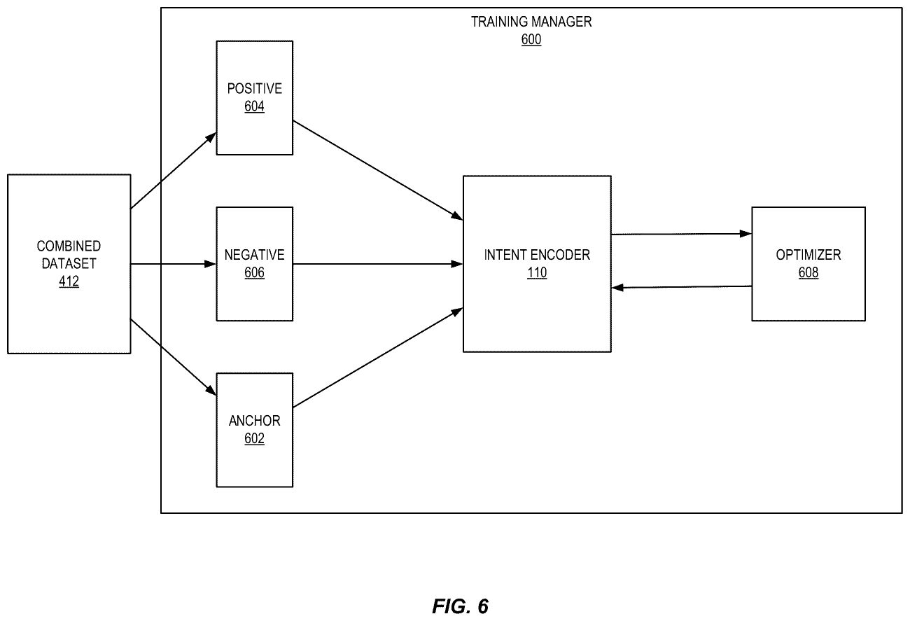

FIG. 6 illustrates a diagram of a process of training an intent encoder, in accordance with one or more embodiments. As shown in FIG. 6, a training manager 600 is responsible for training at least intent encoder 110. In some embodiments, the intent encoder 110 is implemented as a transformer network of one or more transformer models. For example, the transformer network may include one or more DistilBERT, or other lightweight transformer networks. As discussed, the intent encoder 110 is trained using training triplets from the combined dataset 412. The triplets include an anchor 602, a positive example 604, and a negative example 606. In this example, the anchor 602 is an intent or query and the positive 604 and negative 606 examples are background classes. During training, the intent encoder 110 encodes the positive, negative, and anchor examples 602-606 into the same embedding space (e.g., intent/background embedding space 118, discussed above). An optimizer 608 (such as the Adam optimizer) then compares the embeddings using, e.g., cosine similarity or other metric, and trains the encoder (e.g., using gradient descent) based on whether the anchor-positive pair are closer than the anchor-negative pair. This way, the intent encoder 110 learns to encode the anchor 602 closer to the positive example 604 and farther from the negative example 606 in the embedding space.

Ideally, the negative example 606 for each anchor-positive pair is selected to be a hard negative. This means that the negative is chosen as a plausible match, rather than an obvious mismatch. Accordingly, to speed up the training process a set of hard negatives may be generated prior to training. For example, starting with a pretrained encoder, embeddings are generated for each query-background pair (e.g., each anchor-positive pair). For each query-background pair, the top k backgrounds are retrieved. Any retrieved backgrounds that are closer to the query than the paired background (e.g., based on cosine similarity or other metric) are added to the set of hard negatives for that query-background pair. During training, the hard negative used for a given query-background pair can be cycled through during different training epochs. This process may be repeated after training the encoder, to generate a new set of hard negatives. This way, the encoder may be fine-tuned to improve performance in weaker areas.

In some embodiments, to further improve training time the training triplets are generated before training the model (query, positive document, any document from the hard negative set as a negative document) and then used batched in-negatives. This means that each anchor-positive pair should be closer to all other pos, neg pairs in the batch. This is another training technique that leads to better performance and faster convergence time.

In some embodiments, the intent encoder is implemented using DeBERTa transformers. In such instances, the intent encoder models the query and backgrounds and the Adam optimizer and mean pooling are used while training. Furthermore, the relevancy score (e.g., udtri score) discussed above is used for a weighted cross entropy loss function. This allows a query-background loss to be weighted based on how relevant the background is for the query. This adds an inherent ranking signal inside the set of relevant backgrounds. In this example, the encoder is trained as a multiclass problem and use top k accuracy as the main metric.

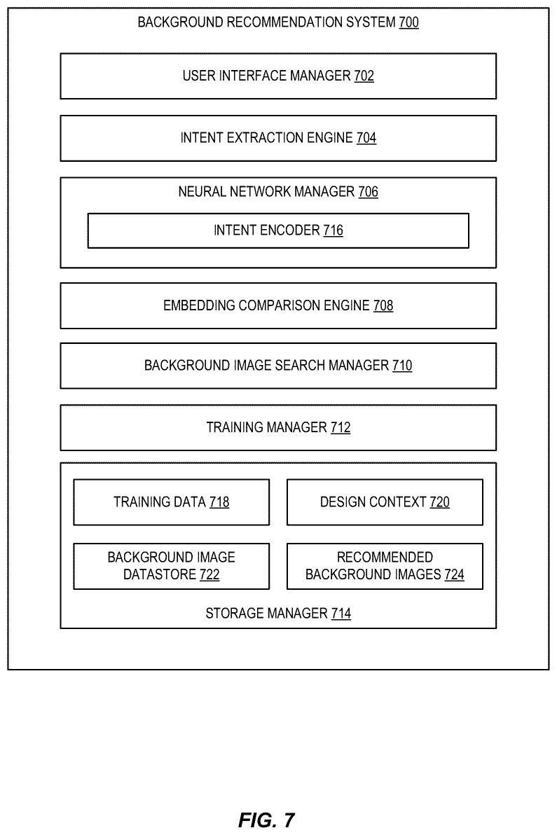

FIG. 7 illustrates a schematic diagram of a background recommendation system (e.g., “background recommendation system” described above) in accordance with one or more embodiments. As shown, the background recommendation system 700 may include, but is not limited to, user interface manager 702, intent extraction engine 704, neural network manager 706, embedding comparison engine 708, background image search manager 710, training manager 712, and storage manager 714. The neural network manager 706 includes intent encoder 716. The storage manager 714 includes training data 718, design context 720, background image datastore 722, and recommended background images 724.

As illustrated in FIG. 7, the background recommendation system 700 includes a user interface manager 702. For example, the user interface manager 702 allows users to provide input data, such as design context 720, to the background recommendation system 700. In some embodiments, the background recommendation system is implemented as part of a digital design system and the user interface manager 702 may provide a user interface through which the user can create a design on a digital canvas using various digital tools, as discussed above. These inputs then form the design context 720 which is passed to the background recommendation system 700 to identify recommended background images.

Additionally, the user interface manager 702 allows users to request the background recommendation system 700 to identify recommended background images based on the design context. For example, the user may interact with a recommendations panel, digital tool, or other user interface element to cause the background recommendation system to identify recommended background images based on a current design context.

As illustrated in FIG. 7, the background recommendation system 700 includes intent extraction engine 704. As discussed, the intent extraction engine 704 receives the design context 720. This can be as the user creates or edits content that is included in the design context or upon request by the user. The intent extraction engine 704 maps the design context to one or more intents. As discussed, the intent extraction engine may be implemented as part of a knowledge graph which may use a classifier or other machine learning model to determine the intent(s).

As illustrated in FIG. 7, the background recommendation system 700 also includes a neural network manager 706. Neural network manager 706 may host a plurality of neural networks or other machine learning models, such intent encoder 716. The neural network manager 706 may include an execution environment, libraries, and/or any other data needed to execute the machine learning models. In some embodiments, the neural network manager 706 may be associated with dedicated software and/or hardware resources to execute the machine learning model(s). As discussed, intent encoder 716 can be implemented as a transformer network. Although depicted in FIG. 7 as hosting a single neural network, in some embodiments neural network manager 706 may host multiple neural networks. Alternatively, the neural networks may be hosted in or across multiple neural network managers and/or as part of different components. As discussed, the intent encoder 716 generates an embedding in an intent-background embedding space corresponding to the received intent. The intent encoder 716 is trained to generate intent embeddings close in the embedding space to matching background embeddings and far in the embedding space from non-matching background embeddings.

As illustrated in FIG. 7, the background recommendation system 700 includes embedding comparison engine 708. The embedding comparison engine 708 can receive the intent embedding from the intent encoder 716 and identify matching background embeddings in the intent-background embedding space. For example, the embedding comparison engine 708 can use a distance metric, similarity metric, or other metric to identify close background embeddings within the embedding space to the received intent embedding. In some embodiments, the embedding comparison engine selects the top k closest background embeddings to the received embeddings. The embedding comparison engine can map their closest background embeddings to corresponding background classes. In some embodiments, the embedding comparison engine 708 can use a decoder to identify the corresponding background class for each closest background embedding.

As illustrated in FIG. 7, the background recommendation system 700 includes background image search manager 710. The background image search manager 710 can receive the background classes from the embedding comparison engine 708 and use the background classes to identify background images from background image datastore 722. For example, the background image search manager 710 may retrieve one or more images corresponding to each background class. These may then be returned or otherwise presented to the user as recommended background images 724.

As illustrated in FIG. 7 the background recommendation system 700 also includes training manager 712. The training manager 712 can teach, guide, tune, and/or train one or more neural networks. In particular, the training manager 712 can train a neural network based on a plurality of training data. For example, the intent encoder 716 can be trained to encode background classes and intents into a shared embedding space, such that matching background classes and intents are encoded as close embeddings within the embedding space and non-matching backgrounds are encoded farther away in the embedding space. Additionally, the intent encoder 716 may be further optimized using loss functions, as discussed above, by backpropagating gradient descents. More specifically, the training manager 712 can access, identify, generate, create, and/or determine training input and utilize the training input to train and fine-tune a neural network.

As illustrated in FIG. 7, the background recommendation system 700 also includes the storage manager 714. The storage manager 714 maintains data for the background recommendation system 700. The storage manager 714 can maintain data of any type, size, or kind as necessary to perform the functions of the background recommendation system 700. The storage manager 714, as shown in FIG. 7, includes the training data 718. The training data 718 can include training triplets from a combined training dataset, as discussed in additional detail above. In particular, in one or more embodiments, the training data 718 includes query-positive background-negative background triplets used by the training manager 712 to train the intent encoder to encode intents and background classes into embeddings in a shared embedding space, as discussed above.

As further illustrated in FIG. 7, the storage manager 714 also includes design context 720. The design context 720 can include content data created or edited by the user, content query data, etc. For example, the design context 720 may include text, shapes, templates, etc. added or created by a user on a digital canvas of a digital design application. In some embodiments, the storage manager 714 may also include a background image datastore 722. The background image datastore 722 may include a plurality of digital images the depict various background content fitting a number of known background classes. The background image datastore 722 may include public image repositories, and/or private image repositories maintained by a design firm, private company, or other entity. Storage manager 714 may further include recommended background images 724. As discussed, these may include a subset of images that have been identified by background recommendation system 700 to be recommended to the user based on their design context.

Each of the components 702-714 of the background recommendation system 700 and their corresponding elements (as shown in FIG. 7) may be in communication with one another using any suitable communication technologies. It will be recognized that although components 702-714 and their corresponding elements are shown to be separate in FIG. 7, any of components 702-714 and their corresponding elements may be combined into fewer components, such as into a single facility or module, divided into more components, or configured into different components as may serve a particular embodiment.

The components 702-714 and their corresponding elements can comprise software, hardware, or both. For example, the components 702-714 and their corresponding elements can comprise one or more instructions stored on a computer-readable storage medium and executable by processors of one or more computing devices. When executed by the one or more processors, the computer-executable instructions of the background recommendation system 700 can cause a client device and/or a server device to perform the methods described herein. Alternatively, the components 702-714 and their corresponding elements can comprise hardware, such as a special purpose processing device to perform a certain function or group of functions. Additionally, the components 702-714 and their corresponding elements can comprise a combination of computer-executable instructions and hardware.

Furthermore, the components 702-714 of the background recommendation system 700 may, for example, be implemented as one or more stand-alone applications, as one or more modules of an application, as one or more plug-ins, as one or more library functions or functions that may be called by other applications, and/or as a cloud-computing model. Thus, the components 702-714 of the background recommendation system 700 may be implemented as a stand-alone application, such as a desktop or mobile application. Furthermore, the components 702-714 of the background recommendation system 700 may be implemented as one or more web-based applications hosted on a remote server. Alternatively, or additionally, the components of the background recommendation system 700 may be implemented in a suite of mobile device applications or “apps.”

As shown, the background recommendation system 700 can be implemented as a single system. In other embodiments, the background recommendation system 700 can be implemented in whole, or in part, across multiple systems. For example, one or more functions of the background recommendation system 700 can be performed by one or more servers, and one or more functions of the background recommendation system 700 can be performed by one or more client devices. The one or more servers and/or one or more client devices may generate, store, receive, and transmit any type of data used by the background recommendation system 700, as described herein.

In one implementation, the one or more client devices can include or implement at least a portion of the background recommendation system 700. In other implementations, the one or more servers can include or implement at least a portion of the background recommendation system 700. For instance, the background recommendation system 700 can include an application running on the one or more servers or a portion of the background recommendation system 700 can be downloaded from the one or more servers. Additionally or alternatively, the background recommendation system 700 can include a web hosting application that allows the client device(s) to interact with content hosted at the one or more server(s).

For example, upon a client device accessing a webpage or other web application hosted at the one or more servers. In one or more embodiments, the one or more servers can provide access to a digital design application in which the user can access one or more digital tools to create or edit a content on a digital canvas. Moreover, the client device can receive a request (i.e., via user input, automatically based on the user's interactions with the digital design application, etc.) to search for recommended backgrounds and provide the request to the one or more servers. Upon receiving the request, the one or more servers can automatically perform the methods and processes described above to identify recommended backgrounds. In response to the request, the one or more servers can provide one or more recommended background images to the client device for display to the user.

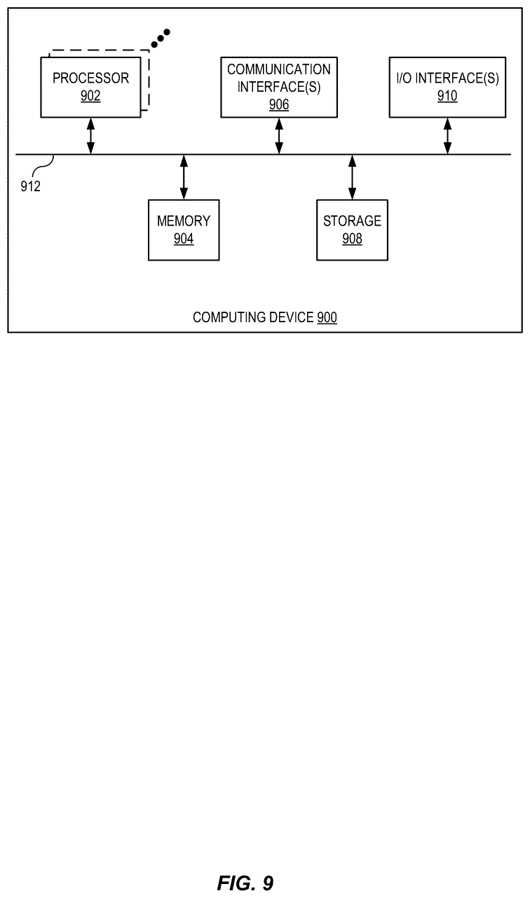

The server(s) and/or client device(s) may communicate using any communication platforms and technologies suitable for transporting data and/or communication signals, including any known communication technologies, devices, media, and protocols supportive of remote data communications, examples of which will be described in more detail below with respect to FIG. 9. In some embodiments, the server(s) and/or client device(s) communicate via one or more networks. A network may include a single network or a collection of networks (such as the Internet, a corporate intranet, a virtual private network (VPN), a local area network (LAN), a wireless local network (WLAN), a cellular network, a wide area network (WAN), a metropolitan area network (MAN), or a combination of two or more such networks. The one or more networks ′M08 will be discussed in more detail below with regard to FIG. 9.

The server(s) may include one or more hardware servers (e.g., hosts), each with its own computing resources (e.g., processors, memory, disk space, networking bandwidth, etc.) which may be securely divided between multiple customers (e.g. client devices), each of which may host their own applications on the server(s). The client device(s) may include one or more personal computers, laptop computers, mobile devices, mobile phones, tablets, special purpose computers, TVs, or other computing devices, including computing devices described below with regard to FIG. 9.

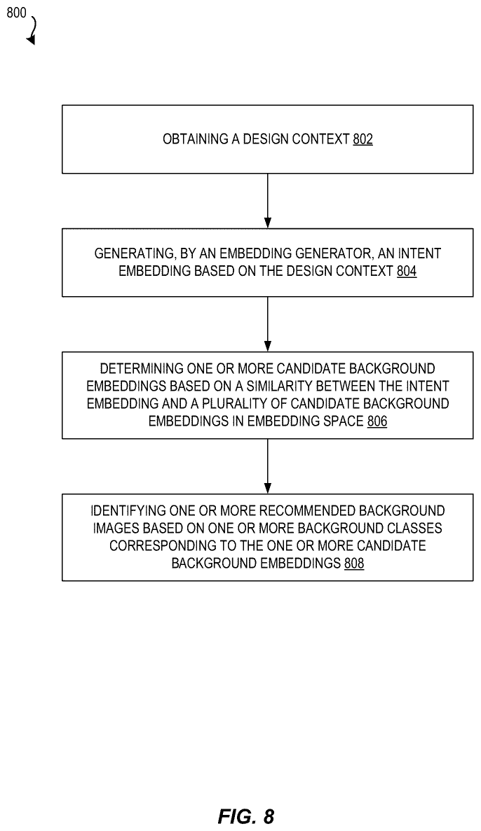

FIGS. 1-7, the corresponding text, and the examples, provide a number of different systems and devices that recommended background images based on user intent. In addition to the foregoing, embodiments can also be described in terms of flowcharts comprising acts and steps in a method for accomplishing a particular result. For example, FIG. 8 illustrates a flowchart of an exemplary method in accordance with one or more embodiments. The method described in relation to FIG. 8 may be performed with fewer or more steps/acts or the steps/acts may be performed in differing orders. Additionally, the steps/acts described herein may be repeated or performed in parallel with one another or in parallel with different instances of the same or similar steps/acts.

FIG. 8 illustrates a flowchart 800 of a series of acts in a method of recommending background images based on user intent in accordance with one or more embodiments. In one or more embodiments, the method 800 is performed in a digital medium environment that includes the background recommendation system 700. The method 800 is intended to be illustrative of one or more methods in accordance with the present disclosure and is not intended to limit potential embodiments. Alternative embodiments can include additional, fewer, or different steps than those articulated in FIG. 8.

As illustrated in FIG. 8, the method 800 includes an act 802 of obtaining a design context. For example, the design context may include a specific query received from the user and/or may be based on what the user has so far created within a design application. For example, when the user opens a design application, they may be presented with a digital canvas in which the user can draw and/or add text, backgrounds, borders, images, and other visual elements. The design context may be received continuously, or periodically, as the user interacts with the background recommendation system and/or other connected systems or applications, such as a design application.

As illustrated in FIG. 8, the method 800 also includes an act 804 of generating, by an embedding generator, an intent embedding based on the design context. In some embodiments, the embedding generator is a transformer network and wherein the embedding generator is trained using a triplet loss on a training dataset comprising a plurality of sets of background class and query pairs. In some embodiments, an intent is determined from the design context. For example, an intent extraction engine can map the design context to one or more intents, as discussed above. As discussed, the intent embedding is generated by the embedding generator from the intent that was extracted from the design context.

As illustrated in FIG. 8, the method 800 also includes an act 806 of determining one or more candidate background embeddings based on a similarity between the intent embedding and a plurality of candidate background embeddings in embedding space. As discussed, the intent embedding is generated in a shared intent-background class embedding space in which intent embeddings are generated close in that embedding space to matching background class embeddings. As a result, matching background class embeddings can be identified by identifying the top k closest background class embeddings to the intent embedding. For example, in some embodiments, determining one or more candidate background embeddings includes calculating a distance metric between the intent embedding and the plurality of candidate background embeddings in the embedding space and selecting the one or more candidate background embeddings based on the distance metric.

As illustrated in FIG. 8, the method 800 also includes an act 808 of identifying one or more recommended background images based on one or more background classes corresponding to the one or more candidate background embeddings. In some embodiments, identifying one or more recommended background images based on one or more background classes includes searching an image library using the one or more background classes. For example, one or more images from each of the one or more background classes can be retrieved from the image library and returned as the recommended background images. In some embodiments, the recommended background images can be returned via a user interface. For example, if the user is designing content in a design application, the recommended background images may be presented via the design interface's user interface. For example, the one or more recommended background images may be presented via the user interface by adding it to the design context.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 9 illustrates, in block diagram form, an exemplary computing device 900 that may be configured to perform one or more of the processes described above. One will appreciate that one or more computing devices such as the computing device 900 may implement the background recommendation system. As shown by FIG. 9, the computing device can comprise a processor 902, memory 904, one or more communication interfaces 906, a storage device 908, and one or more I/O devices/interfaces 910. In certain embodiments, the computing device 900 can include fewer or more components than those shown in FIG. 9. Components of computing device 900 shown in FIG. 9 will now be described in additional detail.

In particular embodiments, processor(s) 902 includes hardware for executing instructions, such as those making up a computer program. As an example, and not by way of limitation, to execute instructions, processor(s) 902 may retrieve (or fetch) the instructions from an internal register, an internal cache, memory 904, or a storage device 908 and decode and execute them. In various embodiments, the processor(s) 902 may include one or more central processing units (CPUs), graphics processing units (GPUs), field programmable gate arrays (FPGAs), systems on chip (SoC), or other processor(s) or combinations of processors.

The computing device 900 includes memory 904, which is coupled to the processor(s) 902. The memory 904 may be used for storing data, metadata, and programs for execution by the processor(s). The memory 904 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 904 may be internal or distributed memory.

The computing device 900 can further include one or more communication interfaces 906. A communication interface 906 can include hardware, software, or both. The communication interface 906 can provide one or more interfaces for communication (such as, for example, packet-based communication) between the computing device and one or more other computing devices 900 or one or more networks. As an example and not by way of limitation, communication interface 906 may include a network interface controller (NIC) or network adapter for communicating with an Ethernet or other wire-based network or a wireless NIC (WNIC) or wireless adapter for communicating with a wireless network, such as a WI-FI. The computing device 900 can further include a bus 912. The bus 912 can comprise hardware, software, or both that couples components of computing device 900 to each other.

The computing device 900 includes a storage device 908 includes storage for storing data or instructions. As an example, and not by way of limitation, storage device 908 can comprise a non-transitory storage medium described above. The storage device 908 may include a hard disk drive (HDD), flash memory, a Universal Serial Bus (USB) drive or a combination these or other storage devices. The computing device 900 also includes one or more input or output (“I/O”) devices/interfaces 910, which are provided to allow a user to provide input to (such as user strokes), receive output from, and otherwise transfer data to and from the computing device 900. These I/O devices/interfaces 910 may include a mouse, keypad or a keyboard, a touch screen, camera, optical scanner, network interface, modem, other known I/O devices or a combination of such I/O devices/interfaces 910. The touch screen may be activated with a stylus or a finger.

The I/O devices/interfaces 910 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O devices/interfaces 910 is configured to provide graphical data to a display for presentation to a user. The graphical data may be representative of one or more graphical user interfaces and/or any other graphical content as may serve a particular implementation.

In the foregoing specification, embodiments have been described with reference to specific exemplary embodiments thereof. Various embodiments are described with reference to details discussed herein, and the accompanying drawings illustrate the various embodiments. The description above and drawings are illustrative of one or more embodiments and are not to be construed as limiting. Numerous specific details are described to provide a thorough understanding of various embodiments.

Embodiments may include other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

In the various embodiments described above, unless specifically noted otherwise, disjunctive language such as the phrase “at least one of A, B, or C,” is intended to be understood to mean either A, B, or C, or any combination thereof (e.g., A, B, and/or C). As such, disjunctive language is not intended to, nor should it be understood to, imply that a given embodiment requires at least one of A, at least one of B, or at least one of C to each be present.

We claim:

1. A method comprising:
obtaining a design context;
generating, by an embedding generator, an intent embedding based on the design context;
determining one or more candidate background embeddings based on a similarity between the intent embedding and a plurality of candidate background embeddings in embedding space; and
identifying one or more recommended background images based on one or more background classes corresponding to the one or more candidate background embeddings.

2. The method of claim 1, further comprising:
determining an intent from the design context.

3. The method of claim 2, wherein generating, by an intent encoder, an intent embedding based on the design context, further comprises:
generating the intent embedding from the intent.

4. The method of claim 1, wherein determining one or more candidate background embeddings based on a similarity between the intent embedding and a plurality of candidate background embeddings in embedding space, further comprises:
calculating a distance metric between the intent embedding and the plurality of candidate background embeddings in the embedding space; and
selecting the one or more candidate background embeddings based on the distance metric.

5. The method of claim 1, wherein identifying one or more recommended background images based on one or more background classes corresponding to the one or more candidate background embeddings, further comprises:
searching an image library using the one or more background classes.

6. The method of claim 1, wherein the embedding generator is a transformer network and wherein the embedding generator is trained using a triplet loss on a training dataset comprising a plurality of sets of background class and query pairs.

7. The method of claim 1 further comprising:
presenting, via a user interface, the one or more recommended background images by adding it to the design context.

8. A non-transitory computer-readable medium storing executable instructions, which when executed by a processing device, cause the processing device to perform operations comprising:
obtaining a design context;
generating, by an embedding generator, an intent embedding based on the design context;
determining one or more candidate background embeddings based on a similarity between the intent embedding and a plurality of candidate background embeddings in embedding space; and
identifying one or more recommended background images based on one or more background classes corresponding to the one or more candidate background embeddings.

9. The non-transitory computer-readable medium of claim 8, wherein the operations further comprise:
determining an intent from the design context.

10. The non-transitory computer-readable medium of claim 9, wherein the operation of generating, by an intent encoder, an intent embedding based on the design context, further comprises:
generating the intent embedding from the intent.

11. The non-transitory computer-readable medium of claim 8, wherein the operation of determining one or more candidate background embeddings based on a similarity between the intent embedding and a plurality of candidate background embeddings in embedding space, further comprises:
calculating a distance metric between the intent embedding and the plurality of candidate background embeddings in the embedding space; and
selecting the one or more candidate background embeddings based on the distance metric.

12. The non-transitory computer-readable medium of claim 8, wherein the operation of identifying one or more recommended background images based on one or more background classes corresponding to the one or more candidate background embeddings, further comprises:
searching an image library using the one or more background classes.

13. The non-transitory computer-readable medium of claim 8, wherein the embedding generator is a transformer network and wherein the embedding generator is trained using a triplet loss on a training dataset comprising a plurality of sets of background class and query pairs.

14. The non-transitory computer-readable medium of claim 8 wherein the operations further comprise:
presenting, via a user interface, the one or more recommended background images by adding it to the design context.

15. A system comprising:
a memory component; and
a processing device coupled to the memory component, the processing device to perform operations comprising:
obtaining a design context;
generating, by an embedding generator, an intent embedding based on the design context;
determining one or more candidate background embeddings based on a similarity between the intent embedding and a plurality of candidate background embeddings in embedding space; and
identifying one or more recommended background images based on one or more background classes corresponding to the one or more candidate background embeddings.

16. The system of claim 15, wherein the operations further comprise:
determining an intent from the design context.

17. The system of claim 16, wherein the operation of generating, by an intent encoder, an intent embedding based on the design context, further comprises:
generating the intent embedding from the intent.

18. The system of claim 15, wherein the operation of determining one or more candidate background embeddings based on a similarity between the intent embedding and a plurality of candidate background embeddings in embedding space, further comprises:
calculating a distance metric between the intent embedding and the plurality of candidate background embeddings in the embedding space; and
selecting the one or more candidate background embeddings based on the distance metric.

19. The system of claim 15, wherein the operation of identifying one or more recommended background images based on one or more background classes corresponding to the one or more candidate background embeddings, further comprises:
searching an image library using the one or more background classes.

20. The system of claim 15, wherein the embedding generator is a transformer network and wherein the embedding generator is trained using a triplet loss on a training dataset comprising a plurality of sets of background class and query pairs.
